(19) United States
(12) Patent Application Publication
(10) Pub. No.: US 2022/0114638 A1
(43) Pub. Date: Apr. 14, 2022

(54) DYNAMICALLY UPDATING ECOMMERCE BASKET

(71) Applicant: NET REWARDS HOLDINGS LIMITED, Torquay (GB)

(72) Inventors: Shane Lee Ambridge, Ringwood (GB); Aidan Peter Coates Wilkinson, Farnham (GB); Paul Philip Roberts, Bedford (GB)

(21) Appl. No.: 17/497,430

(22) Filed: Oct. 8, 2021

Related U.S. Application Data
(60) Provisional application No. 63/089,137, filed on Oct. 8, 2020.

(51) Int. Cl. G06Q 30/06; G06Q 30/02

(52) U.S. Cl. CPC G06Q 30/0629; H04L 63/0272; G06Q 30/0215; G06Q 30/0222

(57) ABSTRACT

A method of providing an enhanced user basket is disclosed. In some implementations, the user basket is a universal basket that may include items from one or more retailers. The user basket may be implemented on a variety of user devices such as a mobile phone, tablet computer, laptop, desktop, or the like. The user basket may be shared from a user to one or more other users. The method includes intercepting a user request for an internet destination provided to a user device; adding a first item displayed at the internet destination to a user basket; determining a first attribute of the first item; determining a second item having a second attribute related to the first attribute; and providing the second item to the user.

### CROSS-REFERENCE TO RELATED APPLICATIONS

The present application claims priority of U.S. Provisional Application No. 63/089,137, filed Oct. 8, 2020, entitled “Dynamically Updating Ecommerce Basket,” the entirety of which is incorporated herein by reference for all purposes.

### BACKGROUND

Examples described herein generally relate to systems and methods related to a dynamically updating user basket.

As consumers of online retailers become more sophisticated and demanding, consumers are increasingly in search of preferred deals. In traditional online shopping, consumers may search for an item (e.g. a product or a service) with the lowest cost, shortest delivery, and/or most favorable return policy, or the like. The consumer search may include multiple retailers and/or many similar or comparable items. Once a consumer finds an item of interest, such as via a search result on a browser, the consumer may realize that the item is more expensive, has a longer delivery time, or other attributes that may make the item less desirable than other similar items. However, such information may be available only after the consumer has navigated to the particular retailer page and/or added the item to a shopping basket and attempted to “checkout” or complete a purchase. Such delayed information and processes, utilize an extensive amount of time and end up frustrating consumers who may ultimately select an item at whim without comparison shopping to avoid the hassles and time. Often, consumers may spend large amounts of time searching the internet for a preferred deal in various item attributes and may never arrive at the preferred deal. Retailers who may have a better deal may not be aware that a consumer is shopping for an item they may supply, missing a possible sale.

Additionally, a retailer may have a reward available as an incentive for completing a transaction. Often, many consumers may not be aware that rewards are available for a particular retailer or for an item and so rewards may be inadvertently forfeited. Additionally, many traditional reward programs involve numerous steps that a user must complete to receive and actually identify or collect a reward.

### BRIEF SUMMARY

A method of providing an enhanced user basket is disclosed. In one implementation, the method includes intercepting a user request for an internet destination provided to a user device; adding a first item displayed at the internet destination to a user basket; determining a first attribute of the first item; determining a second item having a second attribute related to the first attribute; and providing content related to the second item into the user basket. In some implementations, one of the first attribute or the second attribute is one of a price, inventory level, a delivery time, a return policy, or an available reward. In some implementations, the content is one of an image, the price, the inventory level, or the delivery time and is associated with an item entry in the user basket.

In some implementations, the first item is offered for sale at a first website associated with a first retailer and the second item is offered for sale at a second website associated with a second retailer different from and unrelated to the first retailer. The user basket may be a universal basket configured to integrate and display the first item and the second item so as to isolate the formatting of the first website and the second website.

In some implementations, the method includes redirecting the user request to a modified internet destination, wherein the modified internet destination is associated with the internet destination. The modified internet destination may be a web page of the internet destination.

In some implementations, a first portion of the user request is routed through a first network interface; a second portion of the user request is routed through a second network interface; and intercepting the user request includes intercepting the first portion and the second portion, and routing the first portion and the second portion through a secure data channel. The first network interface may be one of a cellular network interface or a Wi-Fi network interface and the second network interface may be the other of the cellular network interface or a Wi-Fi network interface. The secure data channel may be a virtual private network.

In some implementations, the method may include determining that the user request is redirectable.

In some implementations, determining the second item includes using one of an artificial intelligence, machine learning algorithm, scraping a webpage, or natural language processing to determine that the second attribute is related to the first attribute. The second item may be determined based on an internet trend.

In some implementations, the method includes determining a reward based on a user purchase and providing the reward to a user value account. The reward may be a cashback reward.

In some implementations, providing the second item includes providing a link to one or more shopping websites. The one or more shopping websites may be sorted based on a net cost of an item including a reward.

In some implementations, adding the first item includes adding the first item via one of a browser or an application executing on a user device. In some implementations, the method includes displaying the user basket via an application executing on a user device.

In some implementations, the user is a first user and the method includes sharing the user basket with a second user. The first item may be added to the user basket by the first user, and the second attribute of the second item may be related to the second user. The first attribute may be a first language and the second attribute may be a second language different than the first language. The first attribute may be a first currency and the second attribute may be a second currency different than the first currency.

A system of providing an enhanced user basket is disclosed. In one implementation, the system includes a user device including a processing element; a server in electronic communication with the user device; an application executed by the processing element operative to intercept the electronic communication, present a webpage including a first item for sale based on the electronic communication; responsive to a user input, add the first item to a user basket; determine a first attribute of the first item as presented on the webpage; determine a second item having a second attribute related to the first attribute; and provide the second item to the user.

In some implementations, the first item is offered for sale at a first website associated with a first retailer and the second item is offered for sale at a second website associated with a second retailer different from and unrelated to the first retailer.

In some implementations, one of the first attribute or the second attribute is one of a price, inventory level, a delivery time, a return policy, or an available reward. In some implementations, the first attribute is the same or comparable to the second attribute.

In some implementations, the electronic communication is routed through a secure data channel. The user device includes a first network interface and a second network interface, a first portion of the electronic communication is routed through the first network interface and a second portion of the electronic communication is routed through the second network interface.

In some implementations, the application is operative to intercept the first portion of the electronic communication; intercept the second portion of the electronic communication; and route the first portion and the second portion through the secure data channel. The secure data channel may be a virtual private network.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates an example of a system for providing a dynamically updating user basket

FIG. 2 is a flowchart of a method to use a user basket that may be implemented with a system, such as the system of FIG. 1.

FIGS. 3A-3C show example screen shots of the method of FIG. 2.

FIG. 4 illustrates a simplified block diagram for the various devices of the system of FIG. 1.

### DETAILED DESCRIPTION

The present disclosure is related to systems and methods to improve computer systems for enhanced consumer shopping experiences. As the user navigates to various webpages, such as for example, via a listing of search results or from a direct search on a retailer website, the user may select a particular item (e.g., clothing item, accessory, service package, product, etc.) of interest. This selection may include an indication that a user wants to add the item from the online resource to a user basket. Notably, the user basket is not associated with just the retailer website or other online resource, but rather is a basket that will collect items across various resources, retailers, websites, and/or browsers e.g., a universal basket. For example, the user basket may collect items accessed with a user device such as a smart phone, a user device such as a laptop, tablet, or other device. The user basket may collect items accessed via one or more web browsers such as Safari, Chrome, Edge, Internet Explorer, Firefox, browsers or similar functionality within other applications, or the like.

The system may analyze items within the basket, so as to determine an attribute of the item, for example the type of item for which a user is shopping or interested in (e.g., sunglasses, shoes, vacation rentals, and the like), and use this information to identify and locate comparable items. For example, the system may analyze the item information at the specific online resource identified by the user to determine a product universal product code (UPC), stock keeping unit (SKU), product name, size, color, type, brand, etc. for the item. Using this information, the system may then retrieve the same item from different vendors or retailers and/or comparable items that may be similar to, but not exactly the same, as the identified item. The system may analyze these additional items to determine whether they have preferable characteristics, e.g., faster shipping time, lower price, etc., to the current item and add such items to the user basket. As used herein, a user basket may be any collection of items accessible via a user device (which may be stored locally and/or via a network), such as an item list, shopping cart, gift registry (e.g., wedding, graduation, baby shower registry), wish list, or the like. In this manner, the user may then retrieve or access his or her user basket and view a pre-fetched list of related and similar items. This helps users to spend less time manually browsing the internet and other locations for items, while also helping to ensure that at least one or more of the user's preference (e.g., price, shipping time, color, etc.) are satisfied for a particular purchase.

In some embodiments, the system may further indicate to retailers that a user may be interested in a particular product offering or type of offering. From there, retailers may provide one or more related items (e.g., a better deal) to compete for a consumer's business and adjust pricing, rewards, as well as other options that may be tailored to a specific consumer.

As used herein the term reward is meant to encompass something of value given to a user in return for completing an interaction, such as a transaction with a seller. A reward can be a cashback reward where the user is given legal tender in any form. A reward can be points, credits, or a discount to be used against a future purchase from the rewarding seller or a third party.

In one embodiment, the system may include an application (“app”), on a user device that intercepts and analyzes requests such as internet searches and browsing to determine whether the user is intending to purchase an item or service from a seller, (e.g., shopping). As an example, the system intercepts a request for an online resource at a requested destination (e.g., www.brandABCSunglasses.com), where the request may include any electronic communication, data, or traffic to or from a user device and another device. The system intercepts the request and may modify and/or forward the request to a destination other than the original destination. The system may monitor requests between the user device and the server. The system differentiates between redirectable requests (e.g., shopping or retailer based requests) and non-redirectable requests (e.g., social media, text messages, email, and the like). For redirectable requests, the app redirects the request from the user's requested destination to a redirect server. The redirect server may modify the request, for example to indicate a user basket associated with the request or to indicate to the destination server that the user may qualify for a reward upon completion of an interaction with the seller (e.g., purchases an item). For example, the redirect server may modify the request to indicate that the request has been redirected from an affiliate or other site offering a reward. The destination server may recognize the modified request as being associated with a reward, and may differentiate such from requests that access the seller website directly. The server may redirect the request to the user's requested destination, for example a retailer website.

The system may monitor interactions between the user device and the website and determine whether the user has completed a purchase that qualifies for a reward, e.g., cashback. In some embodiments, the system may receive information to determine whether the user has completed a transaction, such as a purchase, that qualifies the user for a reward. For example, the seller may transmit a transaction confirmation to the system upon completion of a qualifying transaction (as determined by the seller's rewards program). Once the system receives a confirmation, it may indicate to the user (e.g., a user notification) that the user qualifies for the reward. The system may award the reward to the user via a user value account such as a virtual wallet or the like. For example, the reward may be considered a cashback reward, or other forms of payment such as bank account credit, retailer “points,” debit card, check, cash, or the like.

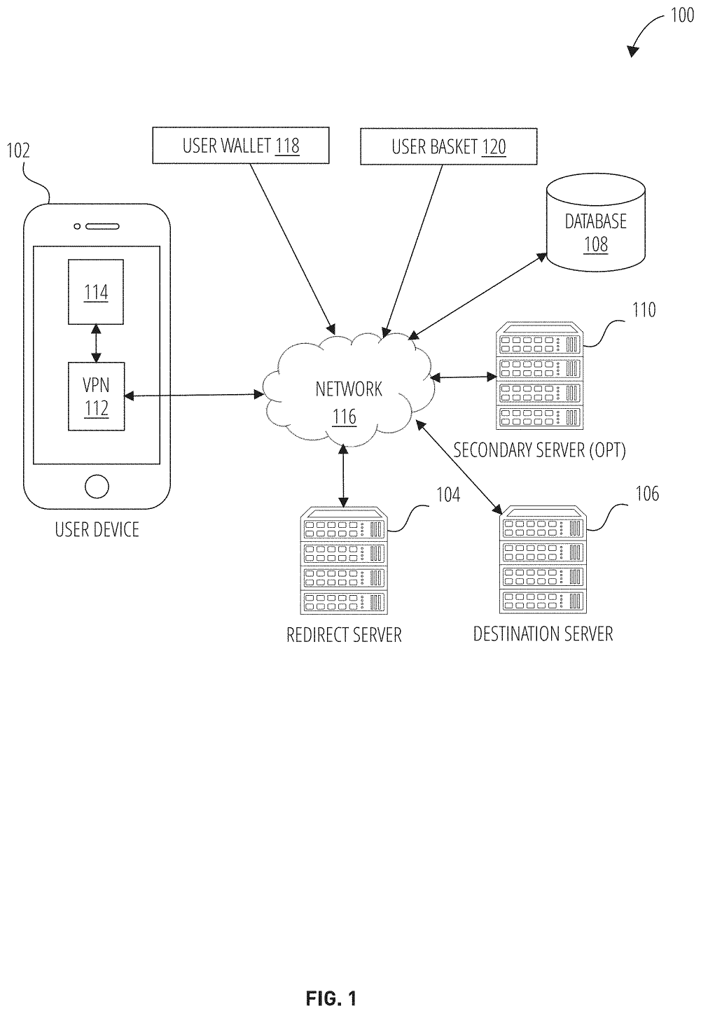

Turning to the figures, examples of the system and methods will be discussed in more detail. FIG. 1 illustrates an example of an improved computer system 100 for providing a dynamically updating user basket. The system 100 may include one or more of a user devices 102, a user value account such as a user wallet 118, a database 108, a redirect server 104, a destination server 106, and optionally one or more secondary servers 110. In various implementations a destination server 106 may be a secondary server 110 and vice versa.

Generally, there may be one or more user devices 102 that interact with the system 100 via the network 116. In many implementations, the system 100 may include multiple user devices 102, allowing individuals to interact separately with the system 100 via separate user devices 102. The user device 102 is any type of computing device that can transmit and receive data from another computing device. For example, the user device 102 may be a smartphone, tablet computer, wearable device, laptop, desktop, server, and the like. In many embodiments, the user device 102 is a portable device.

The destination server 106 or the secondary server 110 may be a computing device hosting a website or other online resource accessible to a user device 102 via the network 116. The destination server 106 or the secondary server 110 may host a seller website such as an online store. The destination server 106 or the secondary server 110 may be a dedicated computing device, a cloud computing service, an edge server (e.g. a content delivery network), or the like.

The network 116 transmits destination server 106 requests between the various components of the system 100. The network 116 and/or the user device 102 may include two or more communication methods (e.g., cellular and Wi-Fi) to communicatively couple the system 100 elements. Any of the devices in the system 100 may be in electronic communication with one another by a network 116 by either or both wired or wireless connections, such as, but not limited to, radio transmissions, Ethernet, cellular network (e.g., 2G, 2G, 4G, 5G), Wi-Fi, local area network, Zigbee, wide area networks, and the like.

In many implementations, the user device 102 may interact with more than one network 116 at the same time. For example, the user device 102 may communicate with a Wi-Fi network and cellular network at the same time. Requests to a destination may be routed through multiple network interfaces. For example, when a user visits a website via a browser or an app 114 on the user device 102, which may be a smart phone connected to both a Wi-Fi network and a cellular telephone network, the user device 102 may split a request between the Wi-Fi and cellular networks even though the request is routed to a single destination. Such data splitting means that the system cannot easily determine whether the request is redirectable as the request may be routed in unexpected or a variety of manners at any given time. It is noted that many cellular devices, such as smartphones and tablets, frequently use such data splitting over two or more network types. As such, in some embodiments, the system may route all data to be transmitted from the user device in order to ensure that requests, regardless of how transmitted, can be analyzed. In some instances, the requests may be analyzed on the user device 102 and then select requests (e.g., redirectable requests discussed below) may be routed to the redirect server.

For example, in many implementations of the system 100, the user device 102 may include an app 114 or onboard software program analyzes and routes a request from the user device 102 to a secure data channel 112. The app 114 may route a request from the user device 102 via any interface (e.g., cellular network, Wi-Fi, wired, Bluetooth, NFC, Wi-Max, Ethernet). In some implementations, the secure data channel 112 is implemented as a virtual private network, VPN 112. The user device 102 communicates with the network 116 via the VPN 112, which may help ensure that an outbound request is captured and routed (even if split between different communication types, e.g., cellular and Wi-Fi). The app 114 may intercept any or all requests between the user device 102 and any network 116. For example, communications between a Wi-Fi network 116 and a cellular network 116 may both be routed by the app 114 through the secure data channel, e.g., VPN 112 to the respective networks and on to a requested destination such as the destination server 106, the secondary server 110, or the app 114 may redirect certain communications, as will be described in further detail below.

In one implementation, the user device is a mobile user device such as a cellular telephone with a network interface for a cellular network and a second network interface to a Wi-Fi network. When the user makes a request for an online resource, such as a website, some portions of the request may pass through the cellular network interface and some portions may pass through the Wi-Fi network interface. The system 100 can nonetheless track and reroute the request as it may intercept data on both the cellular and Wi-Fi networks, such as with the app 114. The intercepted request may be passed through the secure data channel 112. Thus, the request can be analyzed and redirected as disclosed herein, which is not possible with conventional ecommerce systems, which may only detect redirects via one type of communication network.

The database 108 includes mapping data for determining whether a request from a user device 102 is redirectable. In many implementations, a processor on the user device 102 may execute the app 114 to determine whether a request is redirectable. The app 114 may use the database 108 to make assessments on directability. In some implementations, the determination of whether a request is redirectable may take place on a device other than the user device 102, such as by a processor on the redirect server 104, in these implementations, all requests may be routed to the redirect server for analysis and only the redirectable requests are then actually redirected by the server, the remaining requests forwarded through. In these instances, the redirect server 104 may use the database 108 in such determinations. In some implementations, the database 108 may include data indicating that a particular Uniform Resource Locator (URL) is associated with a reward program and requests to that URL may be redirectable to include rewards information. For example, the database 108 may include a whitelist of shopping URLs considered redirectable and optionally a blacklist of URLs that are not redirectable, such as social media, email, streaming media, or the like. In some implementations, the database 108 may store attributes related to redirectable requests other than URLs, for instance, keywords, user preferences, search history, search patterns, user demographic information, or the like.

In some implementations, a blacklist or whitelist is implemented as a lookup table or a list within the database 108 in order to make faster determinations on redirectability. A blacklist or whitelist may be used by the system 100 to compare a root URL of a request against known root URLs. For example, if a request includes a URL such as “www.brandABCSunglasses.com/models/modelA.html”, the system 100 may compare the root

URL of “brandABCSunglasses” against a blacklist or whitelist including that URL root. In some implementations, the system 100 may ignore the top level domain (e.g., “.com”, “.edu”, “.gov”, and the like). In some implementations, the system 100 may compare the top level domain against a blacklist or whitelist of top level domains. For example, the system 100 may determine that a request directed to “www.ABCCollege.edu” is not redirectable because the “.edu” top level domain indicates the request is directed at educational information. In another example, the system 100 may determine that a request including a “.com” may be redirectable, because the request is directed at a commercial website.

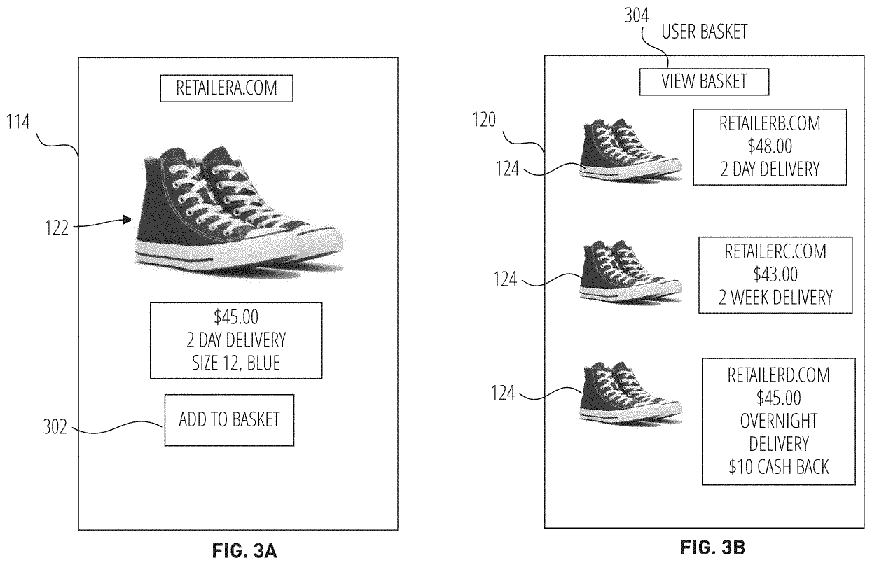

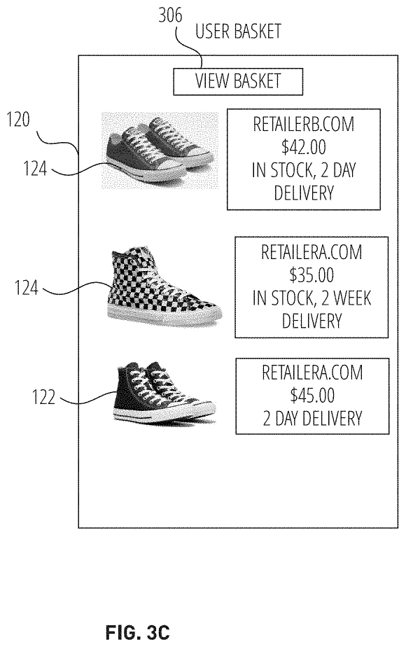

In some implementations, the database 108 may include transaction data, such as a transaction database, related to user transactions. For example, transaction data may include a user identifier; a date, time, and amount of a transaction; an identifier for the other party to the transaction (e.g. seller or retailer); item (e.g., an item 122 shown for example in FIGS. 3A-3C) purchases; banking information; information related to any rewards available to the user (e.g., cashback); or the like. In some implementations, a transaction record, or portions of a record may be hashed with a cryptographic code distinguishing one transaction record from another. Transaction records may be stored in a manner so as to be immutable, such that once completed, cannot be changed. For example, the database 108 may include records of completed transactions in an immutable ledger. Transaction records may be hashed using technologies such as blockchain, or the like.

It may be advantageous to protect transaction data, to protect a user's privacy, and/or as may be mandated by law such as the European General Data Protection Regulation. the California Consumer Privacy Act, or the like. In some implementations, a transaction database or specific records may be encrypted with an encryption key, such that the record may be viewed or read after decrypting the record with the key. The encryption key may be hashed, such as with blockchain, rather than hashing the transaction record itself. In some implementations, an encryption key and a portion of the transaction record may be hashed. Such approaches may have a speed and/or computational cost advantage over methods that hash an entire record, because less data is hashed, yet the record remains immutable and secure. In some implementations, the database, or portions of the database, may be encrypted using other techniques such as: transparent encryption, column-level encryption, symmetric encryption, asymmetric encryption, application-level encryption, or the like.

The database 108 may be implemented as separate databases, including those on the same or separate physical devices, and may be implemented on any suitable device, such as a user device 102, a computing device such as the redirect server 104, an secondary server 110, the destination server 106, a separate computing device, or the like. In various implementations, the database 108 may be implemented in a cloud computing or distributed network. The database 108 may be stored on a user device 102, such as part of the app 114, or on another device of the system 100, such as the redirect server 104.

The redirect server 104 receives a request that the app 114 has determined should be redirected. In some implementations, the redirect server 104 may modify the request and pass the request back to the originating device, such as the user device 102, and the originating device may pass the modified request to the modified destination, such as a website hosted by the destination server 106 or the secondary server 110. In some implementations, the redirect server 104 may modify the request before passing on to the requested destination. For example, the redirect server 104 may append attributes to a routing URL, indicating that a request is associated with a user basket or a that reward is available and can be correctly attributed to the user who completes a qualifying transaction. In some implementations, the system 100 may monitor user interactions without redirecting a request.

The system 100 includes a user basket 120. The user basket 120 may be any suitable online repository that stores items chosen by a user or by the system 100. The user basket 120 may enable a user to add or remove items from the user basket 120. The user basket 120 may enable a user to select an item 122 to store for later purchase, further research, or the like. The user basket 120 may enable a user to sort (such as by net cost considering rewards or other attributes), filter or prioritize items within the user basket 120. As described in further detail with respect to the method 200, the system 100 may determine one or more attributes of an item 122 in the user basket 120 and utilized such attributes to determine additional items 124 related to the originally added item, adding those items or information related to those items to the user basket 120. The user basket may be stored on one or more of the devices of the system 100. For example, the user basket 120 may be stored on the user device 102, the database 108, the redirect server 104, the destination server 106, or the secondary server 110, or another suitable device.

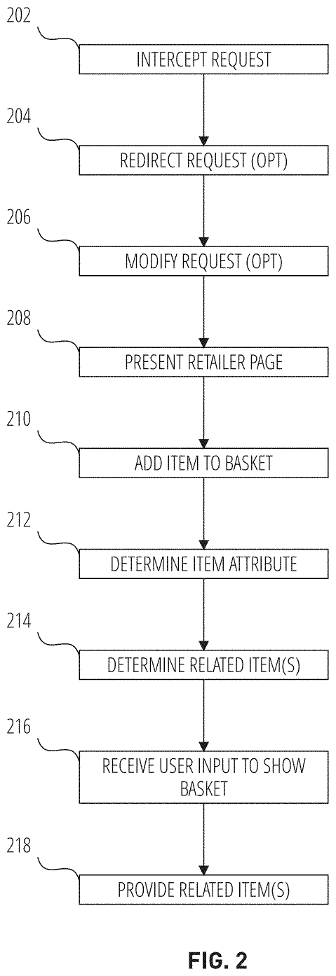

FIG. 2 is a flowchart of a method 200 for generating a user basket 120, such as a dynamically updating user basket, using the system 100. The method 200 may begin in operation 202 and the system 100 intercepts a request for an electronic resource. The request may be intercepted at the user device 102. For example, the app 114 may be configured to intercept any request, including those on any communication interface or multiple communications interfaces, on the user device 102. In some implementations, the system 100 may ask a user to install a one-time certificate to trust the system 100 for Hypertext Transfer Protocol (“HTTP”) or Hypertext Transfer Protocol Secure (“HTTPS”) requests, prior to intercepting a request. In operation 202, the system 100 may use the app 114 to intercept a request on any network interface of the user device 102 and route the request to the secure data channel 112. For example, the app 114 may intercept a portion of a request on a cellular network interface and another portion of a request on a Wi-Fi network interface.

The method may proceed to operation 204 and the system 100 may redirect the intercepted request. For example, the system 100 may optionally redirect the request if the system 100 determines that the request is of a redirectable type. For example, the system 100 may determine that a request is redirectable based on a characteristic or attribute of the request that indicates whether the request or electronic resource requested corresponds to a rewards resource. Examples of redirectable requests include those to retailers, sellers, and other locations with rewards programs, whereas requests not related to shopping, services, or the like, may not be redirected, e.g., email, social media, short messaging service (SMS), media streaming, voice over internet protocol, and the like.

In instances where the system 100 may analyze the request attribute to determine whether the request is redirectable or not, the attribute may indicate the request contains one or more keywords or other data that may be an attribute of the request. The system 100 may compare the request attribute to data indicative of a request type. For example, the attribute may be compared to data in the database 108, e.g., a URL of the request is compared to a whitelist and/or a blacklist of requests of different types. For example, a retailer that sells high-end shoes may have a website with a URL of “https://www.flyshoes.com”. The system 100 may determine that a URL requesting www.flyshoes.com is a “shopping” type of request since the URL includes a product word (e.g., “shoes”) or the URL is listed in the database 108 as a redirectable type. The database 108 may include “www.flyshoes.com” on a whitelist of URLs associated with online shopping and is thus redirectable. Likewise, the system 100 may determine that a request is not redirectable based on keywords contained in the URL, the inclusion of the URL in a blacklist, and/or the top level domain. Some examples of non-redirectable requests may be those associated with social media, text messages, email, media streaming, and the like. For example, the system 100 may determine that a request for a service specializing in streaming cute cat videos with a URL of “https://www.catstream.com” is a “streaming” type of request, which may be determined based on the word “stream” in the URL and/or because “www.catstream.com” is included on a blacklist of URLs associated with streaming services that are not redirectable. Determining which requests are redirectable and which are not may increase the speed or responsiveness of the system 100 relative to redirecting all requests. For example, redirecting all requests may introduce lag to the request, particularly to high bandwidth requests like streaming, video, or audio.

In some implementations, the method 200 may use artificial intelligence (AI) or machine learning (ML) algorithms to determine whether a request is redirectable. For example, the system 100 may analyze search strings in an internet search and determine that patterns of search strings are associated with certain types of requests. For example, a request may include the search strings, “cool shoes for the club”. The system 100 may have been trained with a training data set of similar search requests classified into types. An AI may recognize the search string as falling into a type of “shopping” request. An AI algorithm may learn as requests are processed to achieve higher accuracy of determining request types in operation 206. The AI may be based on a particular user's requests (e.g., individually tailored) or may be based on collective user requests.

Other examples of request attributes include individual data packets or packet headers. These data packets or packet headers are analyzed to determine whether they indicate a protocol associated with a non-redirectable request. For example, when a data packet includes a request to stream media content (e.g., the header indicates that the packet includes data associated with Dynamic Adaptive Streaming over HTTP, a popular media streaming protocol), the system 100 may determine that the request is a “streaming” request and is not redirectable.

The system 100 may determine whether a request is redirectable based on where, within the requesting device, the request originated. For example, a user device may have more than one app installed and executable. The user device 102 may have an app for social media, a text messaging app, an email app, a web browser and so on. The system 100 may determine that a request originated from within the social media app and based on that origination that the request is not redirectable. Likewise, the system 100 may determine that a request originated from within the web browser app and may be redirectable. The system 100 may apply other methods disclosed herein to determine whether the request is redirectable.

Operation 204 may be executed on any device of the system 100, for example the user device 102, the redirect server 104, the destination server 106, the secondary server 110, or another device. In many implementations, the operation 204 may be executed on the user device 102 by the app 114.

In operation 206, the system 100 may optionally modify the request. The modification to the request may be used to determine parameters related to the request, such as the user basket 120 associated with the request, user attributes, item attributes, the availability of rewards, or the like. The modification may be based partly on whether the request is a redirectable type as determined in operation 204. The modified request may include a modified destination for the electronic resource and may be associated with the requested destination. For example, the system 100 may identify a user making the request, how the user was referred to the retailer, and may include data relating to the user basket. The system 100 may add one or more parameters to the request, such as by adding to a requested destination URL or a request body and generate a modified destination.

The request may be modified in any suitable manner. In some implementations, the system 100 may add or modify a query string in a GET HTTP request. The system 100 may add to or modify the request by adding a query string containing a parameter in a name/value pair to the URL. Similarly, in a POST HTTP request, the system 100 may add or modify a parameter in a name/value pair to the body of the HTTP request.

For example, a query string parameter added to the URL may indicate a user identifier such as “user=userABC”. A user identifier may uniquely identify a user and/or a user basket 120 with respect to other users or baskets. Such information may be retrieved from a user record stored in the database 108. Similarly, a parameter may indicate a user and user basket 120 associated with the request. For example, in a GET HTTP request, the system 100 may add to or modify the request by adding a query string containing a parameter in a name/value pair to the URL such as “user_basket=userABC_Basket_1”. Parameters may include user identification, basket identification, session identification, session time/date start, and/or data identifying a chosen item 122 the user wishes to purchase. The system 100 may add tracking code to the request. A search context, such as search keywords, associated with the request may be retained. In some implementations, the system 100 may modify the request such as by adding a web page associated with the requested destination. For example, when a requested destination is “www.flyshoes.com”. The system 100 may modify the request to a modified destination such as “www.flyshoes.com/basket”. In some implementations, a modified destination may include any of the above types of modifications.

In some implementations, a modification to a request may indicate the request is associated with a session, such as with a session identifier. A session may be a set of interactions between a user device 102 and a destination such as a destination server 106 in which the operations of the method 200 are executed. For example, a session may be a consumer journey starting with intercepting a search for a product in operation 202; determining the request is redirectable and redirecting the request in operation 204; and as discussed below, presenting a retailer page in operation 208; adding an item 122 to the user basket 120; determining an attribute of the item 122 in operation 212; determining items 124 related to the attribute; receiving user input to show the user basket 120; and or providing the related items 124.

In some implementations, the operation 204 and/or the operation 206 may be optional. For example, the method 200 may proceed from operation 202 to operation 208 without redirecting and/or modifying the request. An example of such an implementation may include a user session where a user reward is not available. In such implementations, the system may monitor user interactions regardless of the availability of a reward.

The method 200 may proceed to operation 208 and the system 100 presents a retailer page, as shown for example in FIG. 3A. The retailer page may include information about an item 122 related to the request. For example, if the request was a search for shoes for sale at a retailer website (e.g., RetailerA.com), the system 100 may display information related to shoes. The system 100 may display a list of items 122 for the user to choose from and may also provide search, filtering and/or sorting capabilities to the user to refine a search. The system 100 may display attributes related to the request, such as cost, color, size, delivery time, availability, and the like.

The method 200 may proceed to operation 210 and the system 100 adds an item 122 to the basket. The system 100 may provide a user input mechanism 302 such as a virtual button (see FIG. 3A), icon, banner, or other input to receive user input to enable the user to indicate to the system 100 that the item 122 should be added to the user basket 120.

Data stored in the user basket 120 may be transmitted via the network 116 to other portions of the system 100. For example the user input mechanism 302 may be displayed on a user device 102. When a user adds an item 122 to the basket 120, the item 122 added to the basket 120 may be synchronized across the devices of the system 100 such as another user device 102, the redirect server 104, the database 108, the destination server 106, or the secondary server 110. For example, when the user adds an item 122 to the basket 120 on a user device 102 such as a smart phone, the system 100 may synchronize the item 122 to a basket 120 on another user device 102 such as the user's laptop. This functionality may provide a benefit of enabling a user to quickly save an item 122 for later purchase. Further, such functionality may provide a universal basket such that the user and/or the system 100 can add items from different websites or using different user devices to the user basket 120. The user basket 120 may store a link to an item (such as URL), and/or may store additional data or content related to an item, such as an image, price, inventory level, or other attribute. For example, the system 100 may store a link to www.flyshoes.com/shoes 123 as well as other data related to the shoes like price, color, size, etc.

The method may proceed to operation 212 and the system 100 determines one or more attributes of the item 122 in the basket 120. Attributes may be any suitable characteristic or quality of the item 122 that may be relevant to a user's decision to purchase an item 122, or relevant to determining related items 124. The system 100 may determine attributes such as those displayed in operation 210 or 212 like cost, availability, color, size, etc. For example, the system may determine that the item 122 added to the basket 120 has four attributes e.g., the item 122 is a) a pair of, b) blue, c) canvas, d) shoes. Some attributes may be provided by the destination server 106 or a secondary server 110. For example, the destination server 106 may provide an Electronic Data Interchange (“EDI”) system or an application programming interface (“API”) that enables another device (e.g., the redirect server or the user device 102) of the system 100 to automatically receive attributes related to the item 122 in the basket 120. In other examples, the system 100 may scrape a webpage on which the item 122 was displayed to determine attributes of the item 122 in the basket.

In some implementations, a user may create a purchase profile including data related to the user's purchase preferences. The data in the purchase profile may include item attributes preferred by the user such as price, delivery terms, color, size, etc. For example, if the user creates a purchase profile indicating the user is looking for blue trainers that cost $100 or less, the system 100 may determine the item attributes accordingly.

The purchase profile may also include data related to the user, such as demographic data like age, sex, gender, income, residence, height, weight, ethnicity, nationality, and the like. The system 100 may use the user data in the purchase profile to determine item attributes of interest or prioritize desired item attributes based on desired item attributes for a population that is demographically similar to the user. For example, if a user creates a profile indicating the user is a forty-year old male, the system 100 may determine item attributes based on preferences for males ages 35-45, generally. For example, the system 100 may analyze interaction data between users and retailers (e.g., browsing, search patterns, completed purchases, and the like) from users with similar profiles to the current user. The system 100 may aggregate and/or anonymize interaction data from users with profiles similar to that of the current user. The system 100 may associate aggregated interaction data and demographic data. Continuing this example, the system 100 may aggregate interaction data for male users with ages 35-45 and store that data in a database such as the database 108. The system 100 may query the database 108 with a current user's demographic data and return aggregated interaction data from similarly situated users, from which item attributes may be determined. For example, if the aggregated user interaction data for 35-45 year old males indicates a high likelihood of users in that population to prefer chunky, white leather trainers (i.e., “dad shoes”) the system 100 may determine that a color attribute of the item should be white, and a material attribute should be leather.

In other examples, the system 100 may include artificial intelligence (“AI”) machine learning (“ML”) algorithms, analyzing the underlying request (e.g., scraping the HTML of a webpage), natural language processing, machine vision that categorizes images, or the like to determine an attribute of the item 122. For example, the system 100 may analyze an image of the item 122 and determine that the item 122 is a pair of blue shoes, such as with a pattern recognition algorithm In some implementations, the system may determine the item 122 attribute contemporaneously with the item 122 being added to the basket 120. In some implementations, the system 100 may determine the item attribute some time after the item is added to the basket, e.g., minutes, hours, or days after the item 122 is added to the basket 120. The system 100 may store one or more attributes related to the item 122 in the user basket 120. For example, the system 100 may store the attributes displayed in operation 208, and/or other attributes that are not displayed to the user, such a stock level, available discounts, rewards, UPC, SKU, or the like

The method 200 may proceed to operation 214 and the system 100 may determine one or more items 124 related to the attribute of the item 122 for example as determined in operation 212. For example, the system 100 may communicate (or have previously communicated) with other destinations servers 106 and/or secondary servers 110 to determine whether those servers have available items 124 with attributes similar to the attribute of the item 122 in the basket 120. For example, the system 100 may have communicated with the secondary server 110 hosting a retail website for RetailerB.com. Continuing the example above, the system 100 may search the secondary server 110 for blue canvas shoes. In another example, the system 100 may search for a subset of the attributes of the item 122, such as blue shoes, omitting the search for “canvas”. In many implementations, the operation 214 may intelligently pre-fetch items 124 related to the attribute of the item 122 in basket 120. Pre-fetched items may be associated with one or more retailers. For example, pre-fetched items may be retrieved from the retailer associated with the item added to the basket in operation 210, a retailer's competitors, or any other seller. The system 100 may also determine items 124 related to a user attribute, interest, search history, or other information. In some implementations, related items 124 may be determined based on internet or other trends related to an attribute of the item 122. Thus, the basket 120 may have an advantage of providing results of interest to users more quickly than other approaches. Pre-fetching of related items 124 may happen behind the scenes, when a user is not viewing the basket 120. For example, a user may add an item to the basket 120 via the app 114 on the user device 102 and then turn off the device.

The system 100 may pre-fetch related items 124 and populate those items 124 to the basket such that the related items 124 are available to present to the user when the basket 120 is opened. The system 100 may pre-fetch items by searching the internet (e.g., one or more destination servers 106, secondary servers 110, or the like) for items matching one or more attributes. In some implementations, the system 100 may search the database 108 for similar items 124. The system 100 may save similar items 124 to the user basket 120. The system 100 may use methods similar to, or the same as, those used to determine the attribute, as in operation 212. In some implementations, the system 100 may pre-fetch items using aggregated and/or anonymized interaction data between retailers and other users who purchased or viewed the same or similar items as an item in the basket (e.g., an item added in operation 210). For example, the system 100 may aggregate data related to user journeys where a user viewed, searched for, purchased, and/or returned an item in the basket. The aggregated data may relate to any aspect of a journey that included the item in the basket, such as search terms, time of day, day of week, length of journey from initial search to purchase, browsing history, method of payment, other items viewed in the journey, and the like.

In some implementations, the system 100 may pre-fetch items based on a user's own previous interactions with retailers through the system 100 including browsing history; search terms; length of browsing session; items viewed; and/or attributes of items such as, size, color, seasonality (e.g., purchases made in the fall vs. purchases made in the spring, etc.), product rankings (e.g., user reviews), and/or product category (e.g., electronics, housewares, tools, clothes), and the like. In some implementations, related items may be determined based on the location of a user. The system 100 may determine related items that are available in the user's country of residence, the currency used by a user, and/or a language spoken by the user. By pre-fetching related items, the system 100 may respond more quickly than conventional systems.

In some implementations in operation 214, the system 100 may identify other retailers in which the user may be interested. For example, the system may make the user's basket selection known to other retailers than the retailer offering the item 122, such as by communication with one or more secondary servers 110. For example, the system 100 may provide an item attribute to another retailer, such as by a data request transmitted over the network 116. In some implementations, the other retailer may search its own server (e.g., secondary server 110) for a related item 124 and provide the related item 124 back to the system 100. In some implementations, the system 100 may search the secondary server 110 for a related item based on the item attribute. The other retailers may make offers of related items 124 to the user based on the attributes of the item 122. For example, the system 100 may communicate item attributes to a secondary server that may return with offers of related items but with more favorable attributes than those of the retailer of item 122. For example, other retailers may offer a related item 124 at a lower cost than the item 122 and so on. The system 100 may automatically add such related items to the basket 120.

In some implementations, the system 100 may refine a list of related items 124. For example, the system 100 may rank, sort, or filter a list of related items 124 for example to focus the related items based on the item attribute, user preferences, or the like. For example, if the system 100 determines a list of hundreds of related items 124, the system 100 may weigh the related items 124 according to relevance to the item attribute, user preference or the like. The system 100 may add the most highly ranked or most relevant items to the user basket 120.

The method 200 may proceed to operation 216 and the system 100 may receive a user input to show the basket 120. For example, the system 100 may display a user input mechanism 304 such as a button, icon, banner or other input (see FIGS. 3B-3C) to accept user input that the basket 120 should be displayed. The basket 120 may be displayed on any suitable device of the system 100, in many implementations on a user device 102. The user input mechanism 304 may be displayed in a portion of a user interface of the app 114, on a webpage, a window of an operating system of the user device 102, or the like. For example, the app 114 may have a screen with a user input mechanism 304 that receives a user input to show the user basket 120.

The method 200 may proceed to operation 218 and the system 100 may provide the item 122 added by the user to the basket 120 and/or related items 124 added by the system 100. The system 100 may provide a link to one or more shopping websites listing the items 124. The items 124 may be provided in response to an input from the user input mechanism 304, as in operation 216. The system 100 may provide content related to the item 122 or a related item 124. The content may be related to any attribute of a respective item. For example, content may be an image, the price, the inventory level, the delivery time or other attribute, as shown for example in FIGS. 3A-3C. The content may be associated with an item entry in the user basket 120. The operations of the method 200 may be executed in an order other than as shown and some operations may be optional.

In some embodiments, the system 100 may execute the method 200 over time and determine user preferences based on multiple user sessions. For example, the system 100 may monitor user interactions over hours, days, week, months, or longer as in operations 202-210. The system 100 may determine item attributes over time, such as in operation 210. For example, the system 100 may determine that a user prefers shoes in a men's size 10 in blue, based on a number of user sessions. The system 100 may determine related items, such as in operation 214 and provide the related items (e.g., blue size 10 shoes) to the user basket 120 as in operation 218. The system 100 may receive user input to show the basket 120 at any time.

FIGS. 3A-3C show example graphical interface interfaces that may be generated as part of the method 200 such as from a user device like a smart phone, e.g., those generated and displayed during operations 202-218. Some operations may not be associated with a user interface, such as operations 202 or 204, which may be executed with or without displaying information in a user interface. In FIG. 3A, for example, a user session may begin with a request including a search for shoes, such as “trainers” or “sneakers”. The request may be intercepted and redirected as in operations 202 and 204. In operation 208, as shown for example in FIG. 3A, the system 100 returns a retailer page displaying a pair of shoes 122 to the user device 102 via the app 114. The system 100 may display certain attributes related to the shoes 122, for example the price, delivery, color, size, or other attributes. The system may receive other attributes related to the shoes 122 that it does not display, such as inventory levels, or the lowest price at which a seller is willing to sell the shoes. In operation 210 the system 100 may receive a user command such as from the user input mechanism 302 to add the shoes 122 to the basket 120. The system may add attributes related to the shoes 122 to the basket 120 and may synchronize the basket 120 across two or more devices of the system 100.

An example basket 120 is shown for example in FIG. 3B including related items 124 from more than one retailer, as may be determined by the method 200. The basket in FIG. 3B may be considered a universal basket, with items from unrelated retailers from across the internet. For example, in operation 212, the system 100 may determine one or more attributes related to the shoes 122. As shown in FIG. 3B, a universal basket may display related items 124 from different retailers (e.g., as determined in operation 214). For example, the system 100 may search for other items of a similar type, color, size, price, delivery time, shipping cost, reward availability, or the like. The items 124 may be substantially similar to the item 122, but with different delivery, cost, or other attributes. For example, the system 100 may display shoes of the same brand or model but available from different retailers than the shoes 122. For example, the basket 120 may include shoes 124 from Retailer B that cost $48 and have a 2 day delivery; shoes 124 from Retailer C that cost $43 and have a 2 week delivery, and shoes 124 from Retailer D that cost $45 and have overnight delivery.

FIG. 3C shows another example of the basket 120 in which the system 100 has determined related items in operation 214 that are similar, but not the same as the item 122. For example, the basket 120 in FIG. 3C includes red low-rise canvas shoes 124 from Retailer B, checkered high rise shoes 124 from Retailer A, and the shoes 122 that the user added to the basket 120. Thus, the user can easily compare the different offers of shoes 124 compared to the shoes 122 that the user added to the basket 120.

In some examples, the retailers B, C, and/or D may have received information regarding the shoes 122 that the user added to the basket 120 and may have provided offers for related shoes 124. For example, Retailer D may have made an offer to match the price of Retailer A, but with more favorable delivery terms than Retailer A (e.g. overnight vs. 2 day). Similarly, Retailer C may have offered related shoes 124 at a lower price but with a longer delivery than that of the shoes 122. Thus, retailers may be made aware of, and have the chance to compete for, a consumer's business.

In some implementations a universal basket may display items from different retailers, but may integrate the display of related items 124 into a uniform display that isolates items such as related item 124 from the formatting of the retailer's website. For example, as shown in FIGS. 3B and 3C, the user basket 120 may display items with substantially uniform formatting regardless of formatting of a retailer website.

In some implementations, the user basket 120 may be shared from one user to one or more other users, such that the user basket 120 becomes accessible by multiple users, such as a “shared” user basket. For example, a user basket 120 associated with a first user may be generated and populated, such as via the method 200. The first user may then share the user basket with a second user. For example, the first user may nominate or invite the second user to join, follow, or access the user basket 120. For example, the first user may be a parent who creates a user basket 120 and shares it with a second user, the parent's child. The parent may set up a basket for the child to build a Christmas list. The child may browse the internet and add items to the basket that the child hopes to get for Christmas. The parent may access the shared user basket to purchase items selected by the child. An advantage of a shared basket may be that the first user knows they are buying the right items and the system 100 will present the first user with related items that may have better attributes, such as price, delivery, return policy, and the like. In another example, a couple who are engaged to be married may set up a user basket as a wedding registry with desired items and may share the user basket with the couple's friends and family. The friends and/or family may access the shared basket to purchase wedding gifts requested by the couple, and the friends and/or family may be presented with related items to allow for easy comparison shopping.

A user may share a basket via any suitable method. For example, the first user may send a second user a link (e.g., via email, SMS, a messaging function in a social media application, or the like). The link may refer to a resource, such as a shared basket, stored on a location within the system 100 such as the redirect server 104 or another device. When a user selects the link, the user device 102 may be directed a location of the shared basket on the server 104. The link may include information related to an authorization of a user in possession of the link to access the shared basket. For example, the link may have embedded information such as an authorization credential, such that any user with the link may access the shared basket upon following the link. For example, a first user may create a basket stored as a resource on the server 104 and then share a link directed to the shared basket. The link may include an authorization credential to allow the other user to access the shared basket. In another example, a link to share the basket may direct a user to the server such as the server 106, where the user may enter authorization credentials (e.g., a user name and password) to access the shared basket or such credentials may be automatically verified. Such an arrangement may encourage users to create accounts to use the system 100 and help build a user base for the system 100. In another example, the link may indicate a nomination by a first user for a second user to access the shared basket, such that when the link is followed by the second user the second user may log into a device of the system 100 and accept the nomination to the shared basket. In some implementations, the system 100 may push a notification to the app 114 on the second user's device 102 indicating the availability of the shared basket.

The app 114 may include an alert or other such notification to make the second user aware of the shared basket. In some implementations, the app 114 on the user device 102 associated with the first user may generate and display a machine readable code (e.g., barcode, QR code, or the like) indicating an invitation to join a shared basket. A camera on the user device 102 associated with the second user may scan and recognize the machine readable code from an image of the display of the first user device, and may thus join the shared basket. Such a machine readable code may be a one-time-use code, such that it may be used by only one second user (one-to-one) or it may be a reusable code such that any second or subsequent user who receives the code may join the shared basket (one-to-many). The link may optionally include additional information. For example, the link may include an affiliate identifier that indicates an affiliate associated with the shared basket, or an item within the basket. For example, the link may indicate a destination server 106 an/or a secondary server 110 associated with the basket.

The shared basket may optionally include tracking code or other data to indicate data related to an item in the basket, such as whether an item in the basket has been purchased, the availability of the item, shipping information, or the like. In other examples, the shared basket may include a “purchase” type of selection that allows a user to provide information to the system that the product has been purchased or otherwise should be removed from the basket. In yet other examples, the system may be able to dynamically update user history purchases and cross reference those with a shared basket to determine whether an item within a shared basket has been in fact purchased by one or more users. In this manner, the shared basket may help prevent items from being purchased in duplicate by different users. Such additional item information may be included in a link used to share the basket.

In some implementations, the shared user basket may work across country boundaries, with different currencies, and/or across different languages. A first user may set up a shared user basket in a first language, based on a first currency, and while in a first country. The first user may share the user basket with a second user who speaks a second language different than the first language. The second user may be in a different country that uses a different currency. For example, a first user who lives in England and speaks English may create a user basket with prices in pounds sterling and share it with a nephew who lives in Beijing , speaks Mandarin, and uses the Chinese yuan as currency. The system 100 may operate as described, regardless of the language and/or currency used. For example, the system 100 may automatically translate item attributes from one language and/or currency to another. As discussed above, the system 100 may determine related items based, in part, on the location of a user. Continuing the above example, the uncle may add items to the user basket based on items available in England. When the shared basket is shared with the nephew in Beijing, the system 100 may determine the nephew's physical location (e.g., by looking up the nephew's internet protocol address) and may determine related items with the attributes of the items in the shared basket, and which may also be available in China.

A user may determine the level of access and/or control another user has for the shared user basket. For example, if a first user creates a user basket, the first user may share it with a second user such that the second user may view the contents of the basket but may not add or delete items. In another example, the first user may grant a second user full control of the shared basket. In some implementations, the first user may transfer control of the shared user basket to the second user, such that the second user may set permissions and access levels, and/or further share or transfer the shared basket.

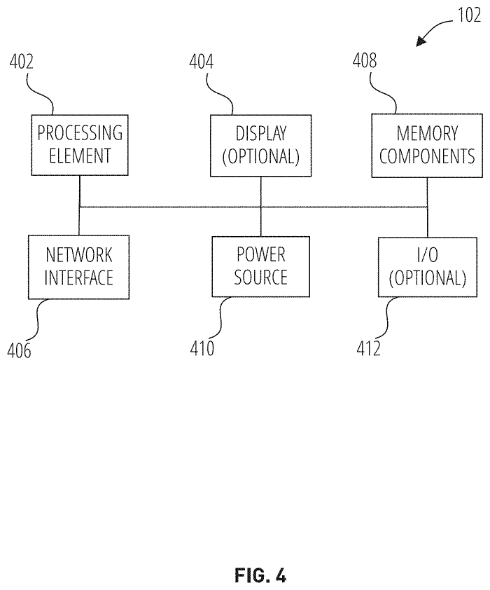

FIG. 4 illustrates a simplified block diagram for the various devices of the system 100 including the user device 102, the redirect server 104, the destination server 106, and the secondary server 110. As shown, the various devices may include one or more processing elements 402, an optional display 410, one or more memory components 412, a network interface 404, a power source 406, and an optional input/output (I/O) interface 408, where the various components may be in direct or indirect communication with one another, such as via one or more system buses, contract traces, wiring, or via wireless mechanisms.

The one or more processing elements 402 may be substantially any electronic device capable of processing, receiving, and/or transmitting instructions. For example, the processing elements 402 may be a microprocessor, microcomputer, graphics processing unit, application specific integrated circuit, field programmable gate array, or the like. It also should be noted that the processing elements 402 may include one or more processing elements or modules that may or may not be in communication with one another. For example, a first processing element may control a first set of components of the computing device and a second processing element may control a second set of components of the computing device where the first and second processing elements may or may not be in communication with each other. Relatedly, the processing elements may be configured to execute one or more instructions in parallel locally, and/or across the network, such as through cloud computing resources.

The display 410 is optional and provides an input/output mechanism for devices of the system 100, such as to display visual information (e.g., images, graphical user interfaces, videos, notifications, and the like) to a user, and in certain instances may also act to receive user input (e.g., via a touch screen or the like). The display may be an LCD screen, plasma screen, LED screen, an organic LED screen, or the like. The type and number of displays may vary with the type of devices (e.g., smartphone versus a desktop computer).

The memory components 412 store electronic data that may be utilized by the computing devices, such as interaction data, user requests, audio files, video files, document files, programming instructions such as to execute the app 114, and the like. For example, the programming instructions may, when executed by a processing element 402, cause the processing element 402 to execute one or more operations of the methods disclosed herein. The memory components 412 may be, for example, non-volatile storage, non-transitory computer-readable storage medium, a magnetic storage medium, optical storage medium, magneto-optical storage medium, read only memory, random access memory, erasable programmable memory, flash memory, or a combination of one or more types of memory components. In many embodiments, the servers 104, 106, and 110 may have a larger memory capacity than the user device 102, with the memory components optionally linked via a cloud network 116 or the like.

The network interface 404 receives and transmits data to and from the network 116 to the various devices of the system 100. The network interface 404 may transmit and send data to the network 116 directly or indirectly. For example, the networking/communication interface may transmit data to and from other computing devices through the network 116. In some embodiments, the network interface may also include various modules, such as an API that interfaces and translates requests across the network 116 to the specific server 104, 106, or 110, or the user device 102. Some devices may have multiple network interfaces 404. For example, a user device 102 such as a smart phone or tablet may have network interfaces 404 for Wi-Fi, Bluetooth, Wi-Max, a cellular telephone network, near field communications, Ethernet, or the like. Network interfaces 404 may be wired or wireless.

The various devices of the system 100 may also include a power source 406. The power source 406 provides power to various components of the user device 102 or servers. The power source 406 may include one or more rechargeable, disposable, or hardwire sources, e.g., batteries, power cord, AC/DC inverter, DC/DC converter, or the like. Additionally, the power source 406 may include one or more types of connectors or components that provide different types of power to the user device 102 and/or servers 104, 106, or 110. In some embodiments, the power source 406 may include a connector (such as a universal serial bus) that provides power to the computer or batteries within the computer and also transmits data to and from the device to other devices.

The I/O interface 408 allows the system 100 devices to receive input from a user and provide output to a user. In some devices, for instance the servers 104, 106, and 110, the I/O interface 408 may be optional. The I/O interface 408 may include a capacitive touch screen, keyboard, mouse, stylus, or the like. The type of devices that interact via the I/O interface 408 may be varied as desired.

The operations of the methods of this disclosure, including methods 200, 300, and 400 may be executed in an order other than as shown and described, and in some instances, operations may be combined or omitted.

In any of the operations of the methods herein, the system 100 may create a container within a container orchestration system such as Kubernetes, Rancher, Docker, Apache Mesos, or the like to execute the operations. For example, a single instance of the method 200 may be executed in a container instantiated for that purpose, and the container may be destroyed upon completion of the method. The container may be instantiated on any device within the system 100, in many implementations on the redirect server 104.

The foregoing description, for purposes of explanation, uses specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A computer implemented method comprising:
intercepting a user request for an internet destination provided to a user device;
adding a first item displayed at the internet destination to a user basket;
determining a first attribute of the first item;
determining a second item having a second attribute related to the first attribute; and
providing content related to the second item into the user basket.

2. The computer implemented method of claim 1, wherein the first item is offered for sale at a first website associated with a first retailer and the second item is offered for sale at a second website associated with a second retailer different from and unrelated to the first retailer.

3. The computer implemented method of claim 2, wherein the user basket is a universal basket configured to integrate and display the first item and the second item so as to isolate the formatting of the first website and the second website.

4. The computer implemented method of claim 1, wherein
one of the first attribute or the second attribute is one of a price, inventory level, a delivery time, a return policy, or an available reward; and
the content is one of an image, the price, the inventory level, or the delivery time and is associated with an item entry in the user basket.

5. The computer implemented method of claim 1 further comprising redirecting the user request to a modified internet destination, wherein the modified internet destination is associated with the internet destination.

6. The computer implemented method of claim 1, wherein:
a first portion of the user request is routed through a first network interface;
a second portion of the user request is routed through a second network interface; and
intercepting the user request includes:
intercepting the first portion and the second portion, and
routing the first portion and the second portion through a secure data channel.

7. The computer implemented method of claim 6, wherein the first network interface is one of a cellular network interface or a Wi-Fi network interface and the second network interface is the other of the cellular network interface or a Wi-Fi network interface.

8. The computer implemented method of claim 6, wherein the secure data channel is a virtual private network.

9. The computer implemented method of claim 5, wherein the modified internet destination is a web page of the internet destination.

10. The computer implemented method of claim 1, further comprising determining that the user request is redirectable.

11. The computer implemented method of claim 1, wherein determining the second item includes using one of an artificial intelligence, machine learning algorithm, scraping a webpage, or natural language processing to determine that the second attribute is related to the first attribute.

12. The computer implemented method of claim 1 further comprising determining a reward based on a user purchase and providing the reward to a user value account.

13. The computer implemented method of claim 1, wherein adding the first item comprises adding the first item via one of a browser or an application executing on a user device.

14. The computer implemented method of claim 1, wherein the first attribute comprises a first language and the second attribute comprises a second language different than the first language.

15. A system comprising:
a user device including a processing element;
a server in electronic communication with the user device;
an application executed by the processing element operative to:
intercept the electronic communication,
present a webpage including a first item for sale based on the electronic communication;
responsive to a user input, add the first item to a user basket;
determine a first attribute of the first item as presented on the webpage;
determine a second item having a second attribute related to the first attribute; and
provide the second item to the user.

16. The system of claim 15, wherein the electronic communication is routed through a secure data channel, wherein the user device includes a first network interface and a second network interface, a first portion of the electronic communication is routed through the first network interface and a second portion of the electronic communication is routed through the second network interface.

17. The system of claiml6, wherein the application is operative to:
intercept the first portion of the electronic communication;
intercept the second portion of the electronic communication; and
route the first portion and the second portion through the secure data channel.

18. The system of claim 17, wherein the secure data channel is a virtual private network.

19. The system of claim 18, wherein the first attribute is the same or comparable to the second attribute.
